(19) United States
(12) Patent Application Publication
(10) Pub. No.: US 2011/0169923 A1
(43) Pub. Date: Jul. 14, 2011

(54) Flow Separation for Stereo Visual Odometry

(75) Inventors: Frank Dellaert, Atlanta, GA (US); Michael Kaess, Atlanta, GA (US); Kai Ni, Atlanta, GA (US)

(73) Assignee: GEORGIA TECH RESEARCH CORPORATIOTION, Atlanta, GA (US)

(21) Appl. No.: 12/900,581

(22) Filed: Oct. 8, 2010

Related U.S. Application Data
(60) Provisional application No. 61/249,805, filed on Oct. 8, 2009.

(51) Int. Cl. H04N 13/02; G06K 9/00

(52) U.S. Cl. 348/47; 382/153; 348/E13.074; 901/1

(57) ABSTRACT

In a method for determining a translation and a rotation of a platform, at least a first frame and a previous frame are generated. Points are matched between images generated by two stereoscopic sensors. Points are matched to corresponding stereo feature matches between two frames, thereby generating a set of putative matches. Putative matches that are nearer to the platform than a threshold are categorized as near features. Putative matches that are farther to the platform than the threshold are categorized as distance features. The rotation of the platform is determined by measuring a positional change in two of the distant features. The translation of the platform is determined by compensating one of the near features for the rotation and then measuring a change in one of the near features measured between the first frame and the second frame.

### CROSS-REFERENCE TO RELATED APPLICATION(S)

This application claims the benefit of U.S. Provisional Patent Application Ser. No. 61/249,805, filed Oct. 8, 2009, the entirety of which is hereby incorporated herein by reference.

### STATEMENT OF GOVERNMENT INTEREST

This invention was made with government support under contract No. FA8650-04-C-7131, awarded by the United States Air Force. The government has certain rights in the invention.

### BACKGROUND OF THE INVENTION

1. Field of the Invention

The present invention relates to video processing systems and, more specifically, to a video processing system used in stereo odometry.

2. Description of the Related Art

Visual odometry is a technique that estimates the egomotion (the motion of the platform on which sensors, such as cameras, used to determine the motion are mounted) from images perceived by moving cameras. A typical use is autonomous navigation for mobile robots, where getting accurate pose estimates is a crucial capability in many settings. Visual odometry does not require sensors other than cameras, which are cheap, passive and have low power consumption. Therefore, there are many interesting applications ranging from search and rescue over reconnaissance to commercial products such as entertainment and household robots. Furthermore, visual odometry lays the foundation for visual simultaneous localization and mapping (SLAM), which improves large-scale accuracy by taking into account long-range constraints including loop closing.

Visual odometry is at its heart a camera pose estimation technique and has seen considerable renewed attention in recent years. One system uses visual odometry and incorporates an absolute orientation sensor to prevent drift over time. Another system employs a real-time system using a three point algorithm, which works in both monocular and stereo settings. Another system uses a loopy belief propagation to calculate visual odometry based on map correlation in an off-line system. Some systems also use omnidirectional sensors to increase the field of view. For example, one system employs an image-based approach that has high computational requirements and is not suitable for high frame rates. Large-scale visual odometry in challenging outdoor environments has been attempted, but has a problem handling degenerate data. One system remembers landmarks to improve the accuracy of visual odometry.

Most current visual odometry systems use the random sample consensus (RANSAC) algorithm for robust model estimation, and are therefore susceptible to problems arising from nearly degenerate situations. The expression “degenerate data” refers to data that is insufficient for constraining a certain estimation problem. Nearly degenerate data means that there are only a few data points without which the remaining data is degenerate. RANSAC generally fails to provide an optimal result when directly applied to nearly degenerate data.

In visual odometry nearly degenerate data occurs for a variety of reasons, such as when imaging ground surfaces with low texture, imaging in bad lighting conditions that result in overexposure, and motion blur due to movement of either the platform or objects being imaged. The consequence of degenerate data is that multiple runs of RANSAC on the same data may yield different results.

Therefore, there is a need for visual odometry system that is efficient and handles degenerate data.

### SUMMARY OF THE INVENTION

The disadvantages of the prior art are overcome by the present invention which, in one aspect, is a method for determining a translation and a rotation of a platform in a three-dimensional distribution of a plurality of objects, in which at least a first frame and a previous frame of a first two-dimensional projection of a three-dimensional distribution of objects is generated with a first sensor. Each frame includes a first plurality of features. At least a first frame and a previous frame of a second two-dimensional projection of the three-dimensional distribution of objects is generated with a second sensor. Each frame includes a second plurality of features. Points in the first two-dimensional projection are matched to points in the second two-dimensional projection in a first frame generated by the first sensor and the second sensor, thereby generating a set of stereo feature matches. Points in the stereo feature matches are matched to corresponding stereo feature matches in a previous frame generated by the first sensor and the second sensor, thereby generating a set of putative matches. The putative matches that are nearer to the platform than a threshold are categorized as near features. The putative matches that are farther to the platform than the threshold are categorized as distance features. The rotation of the platform is determined by measuring a positional change in at least two of the distant features measured between the first frame and the second frame. The translation of the platform is determined by compensating at least one of the near features for the rotation and then measuring a change in the at least one of the near features measured between the first frame and the second frame.

In another aspect, the invention is a method, operable on a processor, for determining a translation and a rotation of a platform in a three-dimensional distribution of a plurality of objects. At least a first frame and a previous frame of a first two-dimensional projection of a three-dimensional distribution of objects is generated with a first camera, wherein each frame includes a first plurality of features. At least a first frame and a previous frame of a second two-dimensional projection of the three-dimensional distribution of objects is generated with a second camera, wherein each frame includes a second plurality of features. Points in the first two-dimensional projection are matched to points in the second two-dimensional projection in a first frame generated by the first camera and the second camera, thereby generating a set of stereo feature matches. Points in the stereo feature matches are matched to corresponding stereo feature matches in a previous frame generated by the first camera and the second camera, thereby generating a set of putative matches. The putative matches that are nearer to the platform than a threshold are categorized as near feature and the putative matches that are farther to the platform than the threshold are categorized as distance features. The rotation of the platform is determined by executing steps including: repeatedly generating a rotational model based on a positional change of a first distance feature and a second distance feature between the first frame and the previous frame for a plurality of first distance features and second distance features selected from the putative matches, thereby resulting in a plurality of rotational models; employing an iterative statistical method to determine which of the rotational models best corresponds to the distance features in the putative matches; and selecting the rotational model that best corresponds to the distance features in the putative matches to represent the rotation. At least one of the near features is compensated for the rotation and then translation is determined by executing the following steps: repeatedly generating a translational model based on a positional change of a near feature between the first frame and the previous frame for a plurality of near features selected from the putative matches, thereby resulting in a plurality of translational models; employing the iterative statistical method to determine which of the translational models best corresponds to the near features in the putative matches; and selecting the translational model that best corresponds to the near features in the putative matches to represent the translation.

In yet another aspect, the invention is an apparatus for determining a translation and a rotation of a platform in a three-dimensional distribution of a plurality of objects. The platform includes a first sensor and a second sensor. The first sensor is configured to project the three-dimensional distribution onto a first two-dimensional projection. The first two-dimensional projection includes a first plurality of points that each correspond to a different object of the plurality of objects. The second sensor is configured to project the three-dimensional distribution onto a second two-dimensional projection. The first two-dimensional projection includes a second plurality of points that each correspond to a different object of the plurality of objects. A processor is in communication with the first sensor and the second sensor. The processor is configured to execute a plurality of steps, including: match points in the first two-dimensional projection to points in the second two-dimensional projection in a first frame generated by the first sensor and the second sensor, thereby generating a set of stereo feature matches; match points in the stereo feature matches to corresponding stereo feature matches in a previous frame generated by the first sensor and the second sensor, thereby generating a set of putative matches; categorize as near features the putative matches that are nearer to the platform than a threshold and categorize as distance features the putative matches that are farther to the platform than the threshold; determine the rotation of the platform by measuring a change in at least two of the distant features measured between the first frame and the second frame; and determine the translation of the platform by compensating at least one of the near features for the rotation and then measuring a change in the at least one of the near features measured between the first frame and the second frame.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram of a platform on which a processor and two cameras are mounted.

FIG. 2 is a top plan view of an area and a distribution of objects on which a platform of the type shown in FIG. 1 moves.

FIG. 3 is a schematic diagram showing two frames from two cameras.

FIG. 4 is a flowchart showing one method for visual odometry.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

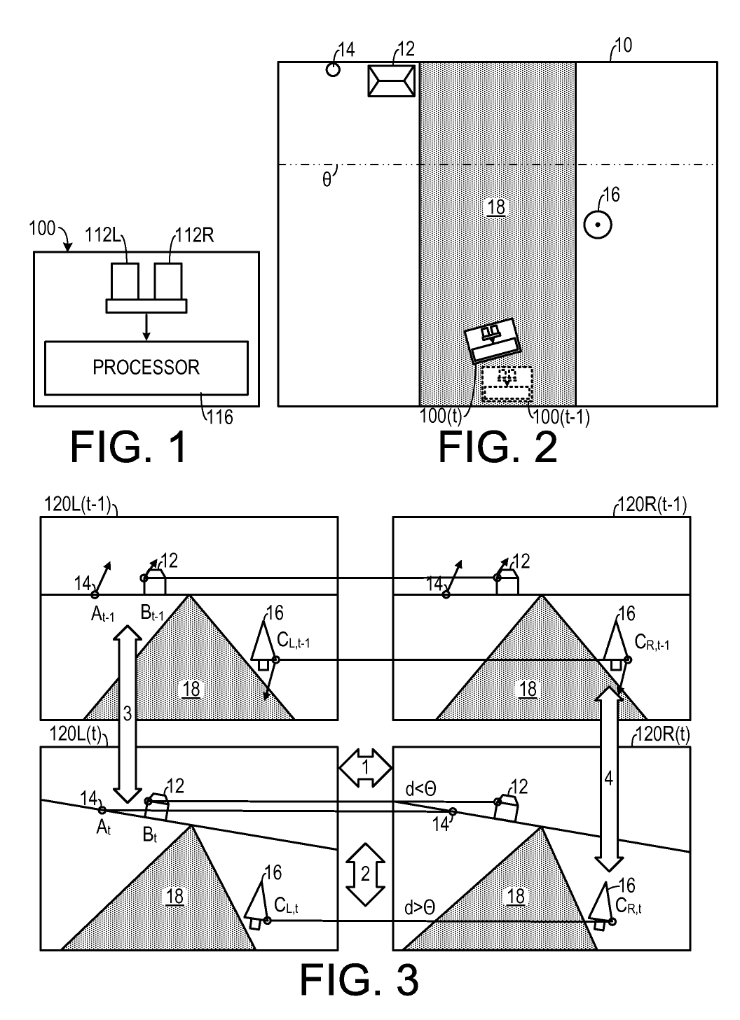

As shown in FIG. 1, one embodiment operates on a processor 116 that is associated with a mobile platform 100, such as a robot. The processor 116 is in communication with a left camera 112L and a right camera 112R, that form a stereo camera pair. (It should be noted that other types of stereographic sensors could be employed. Such sensors could include, for example, directional sound sensors, heat sensors and the like.) As shown in FIG. 2, the platform 100 is capable of moving through a three-dimensional region 10 that includes a plurality of objects distributed therethrough. For example, the platform 110 may move down a road 18 and objects such as a building 12, an topographic feature 14 and a tree 16 may be visible to the cameras 112L and 112R. The platform might assume a series of positions as it moves and the cameras 112L and 112R could capture successive frames at each position. For example, a first frame could be captured when the platform 100 has a position (t−1) and a second frame could be captured when the platform 100 has a position (t).

As shown in FIG. 3, the left camera 112L would capture frame 120L(t−1) at time (t−1) and frame 120L(t) at time (t). Similarly, the right camera 112R would capture frame 120R(t−1) at time (t−1) and frame 120R(t) at time (t).

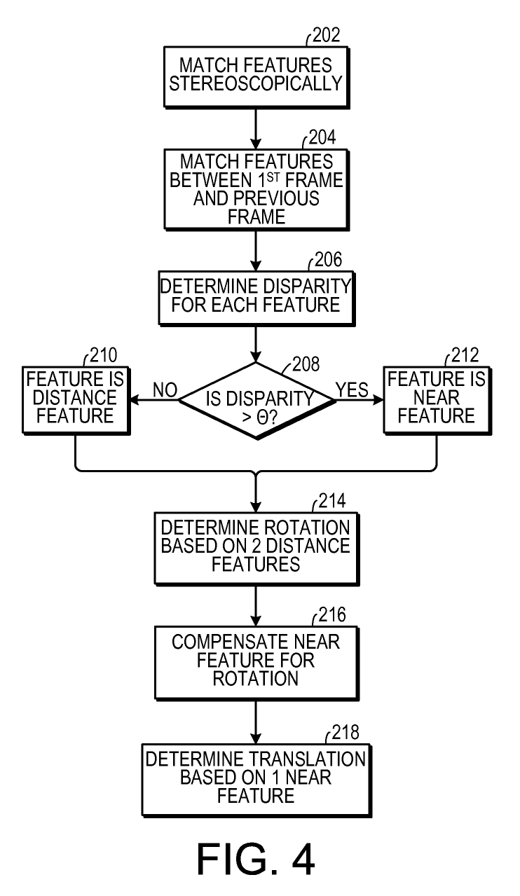

In one embodiment, as shown in FIG. 4, determination of rotation and translation of the platform can employ the following steps. Once at least two successive frames have been captured by both cameras, the system matches features 202 between the two cameras stereoscopically for each frame, thereby generating a set of stereo feature matches. Next, the stereo feature matches are matched between the two successive frames 204. Also, the disparity of each feature between the cameras is determined 206 and then the system determines 208 if the disparity is greater than a threshold θ. If the disparity is not greater than the threshold θ, then feature is classified as a distance feature 210. If the disparity is greater than the threshold θ, then feature is classified as a near feature 212. The rotation of the platform 214 is determining by positional differences of at least two distance features between frames. Once the rotation is determined, the near features are normalized to compensate for the rotation 216 and the system determines the translation based on a change of one near feature 218 between frames.

Returning to FIG. 1, one representative embodiment performs the following four steps on each new stereo pair of frames: 1. Perform sparse stereo and putative matching; 2. Separate features based on disparity; 3. Recover rotation with two-point RANSAC; and 4. Recover translation with one-point RANSAC.

These steps will be described below in greater detail. We assume that the cameras provide rectified images with equal calibration parameters for both cameras of the stereo pair, in particular focal length f and principal point (u₀,v₀). We define the reference camera to be the one whose pose is tracked. The other view is defined by the baseline b of the stereo pair. Camera poses are represented by a translation vector t, and the three Euler angles yaw φ, pitch θ and roll ψ, or alternatively the corresponding rotation matrix R.

Sparse Stereo and Putative Matches: We extract features in the current frame and establish stereo correspondences between the left and right image of the stereo pair. For a feature in one image, the matching feature in the other is searched for along the same scan line, with the search region limited by a maximum disparity. As there are often multiple possible matches, appearance is typically used and the candidate with lowest difference in a small neighborhood accepted, resulting in the set of stereo features [symbol] ={uᵢ, vᵢ, uᵢ′}, where (u, v) is the location of a feature in the reference frame and (u′, v) is the corresponding feature in the other frame.

Based on the stereo features [symbol] from the current frame and the features [symbol] ₜ₋₁ from the previous frame we establish putative matches. For a feature in the previous frame, we predict its location in the current frame by creating a three-dimensional (3D) point using disparity and projecting it back. For this re-projection we need to have a prediction of the vehicle motion, which is obtained in one of the following ways:
Odometry: If wheel odometry or IMU are available.
Filter: Predict camera motion based on previous motion.
Stationary assumption: At high frame rate we obtain a small enough motion to approximate by a stationary camera.

As the predicted feature locations are not exact in any of these cases, we select the best of multiple hypotheses. We use the approximate nearest neighbors (ANN) algorithm to obtain a small set of features efficiently within a fixed radius of the predicted location. The best candidate based on template matching is accepted as a putative match. We denote the set of putative matches with [symbol] As some putative matches will still be wrong, we use a robust estimation method below to filter out incorrect matches.

Separate Features: We separate the stereo features based on their usefulness in establishing the rotational and the translational components of the stereo odometry. The key idea is that small changes in the camera translation do not visibly influence points that are far away. While points at infinity are not influenced by translation and are therefore suitable to recover the rotation of the camera, there might only be a small number or even no such features visible due to occlusion, for example in a forest or brush environment. However, as the camera cannot translate far in the short time between two frames (0.067 seconds for our 15 frames per second system), we can also use points that have disparities somewhat larger than 0. Even if the camera translation is small, however, if a point is close enough to the camera its projection will be influenced by this translation.

We find the threshold θ on the disparity of a point for which the influence of the camera translation can be neglected. The threshold is based on the maximum allowed pixel error given by the constants Δu and Δv, for which values in the range of 0.1 to 0.5 seem reasonable. It also depends on the camera translation t=(tₓ, t_{y}, t_{z}) that can again be based on odometry measurements, a motion filter, or a maximum value provided by physical constraints of the motion. Considering only the center pixel of the camera as an approximation, we obtain the disparity threshold

$$θ = max \{ \frac{b}{\frac{{t}_{x}}{Δ u} - \frac{{t}_{z}}{f}} , \frac{b}{\frac{{t}_{y}}{Δ v} - \frac{{t}_{z}}{f}} \} \qquad ( 1 )$$

We separate the putative matches into the set [symbol] = [symbol] disparity<0} that is useful for estimating the rotation, and the set [symbol] = [symbol] disparity>0} that is useful for estimating the translation. Note that we always have enough putative matches in [symbol] even if the robot is close to a view obstructing obstacle, due to physical constraints. As the robot gets close to an obstacle, its speed has to be decreased in order to avoid a collision, therefore increasing the threshold θ, which allows closer points to be used for the rotation estimation. On the other hand, it is possible that all putative matches have disparities below the threshold θ, in particular for t=0. In that case we still have to use some of the close putative matches for calculating the translation, as we do not know if the translational speed of the camera is exactly 0 or just very small. We therefore always use a minimum number of the closest putative matches for translation estimation, even if their disparities fall below θ.

Rotation: Two-point-RANSAC: We recover the rotational component R of the motion based on the set of putative matches [symbol] that are not influenced by translation. For points at infinity it is straightforward to recover rotation based on their direction. Even if points are close to the camera such that reliable depth information is available, but the camera performs a pure rotational motion, the points can be treated as being at infinity, as their depths cannot be determined from the camera motion itself. Even though the camera's translation is not necessarily 0 in this case, we have chosen the threshold θ so that the resulting putative matches [symbol] can be treated as points at infinity for the purpose of rotation estimation. We therefore take a monocular approach to rotation recovery.

While the set of putative matches contains outliers, let us for a moment assume that the matches

(z_{i,t}^{R},z_{i,t-1}^{R})ε [symbol] with z_{i,t}^{R}=(u_{i,t}^{R},v_{i,t}^{R}) and z_{i,t-1}^{R}=(u_{i,t-1}^{R},v_{i,t-1}^{R})

are correct and therefore correspond to the homogeneous directions (ie. wᵢ^{R}=0)

Xᵢ^{R}=[xᵢ^{R} yᵢ^{R} zᵢ^{R} 0]^{T} (2)

Two such matches are necessary to determine the rotation of the camera for either of the following two methods:

We estimate the rotation R together with n directions−2 degrees of freedom, because Xᵢ^{R} is homogeneous with (wᵢ^{R}=0), yielding 3+2n degrees of freedom (DOF). Each match yields 4 constraints, therefore n=2 is the minimum number of correspondences needed to constrain the rotation.

We estimate only the rotation R, by using the features from the previous time t−1 to obtain the direction of the points. This yields 3 DOF, with only 2 remaining constraints per match, again yielding n=2.

For pure rotation (t=0) the reprojection error E is

$$E = {‖ {z}_{i}^{R} - {v}^{R} ( R , [ \begin{matrix}{x}_{i}^{R} \\ {y}_{i}^{R} \\ {z}_{i}^{R}\end{matrix} ] ) ‖}^{2} \qquad ( 3 )$$

where (u,v)=v^{R}(R,X) is the monocular projection of point X into the camera at pose Rt=0. We numerically obtain an estimate for the rotation R and optionally the point directions by minimizing the non-linear error term

$${R}_{t} = {arg min}_{{R}_{t}} {\sum }_{i , τ ∈ \{ t , t - 1 \}} {‖ {z}_{i , τ}^{R} - {v}^{R} ( {R}_{τ} , [ \begin{matrix}{x}_{i}^{R} \\ {y}_{i}^{R} \\ {z}_{i}^{R}\end{matrix} ] ) ‖}^{2} \qquad ( 4 )$$

where Rₜ₋₁=I and therefore Rₜ the rotational component of the visual odometry. Note that we also need to enforce

∥[xᵢ^{R} yᵢ^{R} zᵢ^{R}]^{T}∥²=1

to restrict the extra degree of freedom provided by the homogeneous parameterization.

While we have assumed correct matches so far, the putative matches in [symbol] are in fact noisy and contain outliers. We therefore use the random sample consensus (RANSAC) algorithm to robustly fit a model. The sample size is two, as two putative matches fully determine the camera rotation, as discussed above. RANSAC repeatedly samples two points from the set of putative matches and finds the corresponding rotation. Other putative matches are accepted as inliers if they agree with the model based on thresholding the re-projection error E from (3). Sampling continues until the correct solution is found with some fixed probability. A better rotation estimate is then determined based on all inliers. Finally, this improved estimate is used to identify inliers from all putative matches, which are then used to calculate the final rotation estimate \hat{R}.

While RANSAC uses two features in the process to determine the rotation, the final estimate for rotation is based on all inliers that voted for that minimum sample. For example, if the 2-point sample with the most votes (say 240) was the best rotation, then at the end of phase 1 all 242 (240+2) inliers are used to obtain the final rotation estimate.

Translation—One-point RANSAC: Based on the now known camera rotation, we recover the translation from the close putative matches [symbol] We denote a putative match as z_{i,t}^{t} and the corresponding 3D points as Xᵢ^{t}. Each measurement imposes 2×3=6 constraints, i.e. z_{i,t}^{t}=(u_{i,t}^{t}, v_{i,t}^{t}, u′_{i,t}^{t}) and z_{i,t-1}^{t}=(u_{i,t-1}^{t}, v_{i,t-1}^{t}, u′_{i,t-1}^{t}), which now includes stereo information in contrast to determining rotation with two-point RANSAC. Intuitively we can recover the translation from a single putative match, as each of the two stereo frames defines a 3D point and the difference between the points is just the camera translation. Practically we again have two different approaches:

(1.) We estimate both the translational component t with 3 DOF and the 3D points {Xᵢ^{t}}ᵢ with 3 DOF each. Each measurement contributes 6 constraints, therefore a single match will make the system determinable.

(2.) We estimate only the translation t yielding 3 DOF, by using the previous stereo feature to generate the 3D point. Each measurement then only contributes 3 constraints, again requiring only a single match to constrain the camera translation.

Similar to determining rotation with two-point RANSAC, the translation is recovered by optimizing over the translation and optionally the 3D points:

$${t}_{t} , {\{ {X}_{i}^{t} \}}_{i} = {arg min}_{{t}_{t} , {\{ {X}_{i}^{t} \}}_{i}} {\sum }_{i , τ ∈ \{ t , t - 1 \}} {‖ {z}_{i , τ}^{t} - {v}^{t} ( {\hat{R}}_{τ} , {t}_{τ} , {X}_{i}^{t} ) ‖}^{2} \qquad ( 5 )$$

where (u,v,u′)=v^{t}(R,t,X) is the stereo projection function, and we choose Rₜ₋₁, tₜ₋₁ to be a camera at the origin, and Rₜ=\hat{R} is the rotation recovered by the two-point algorithm. Consequently, tₜ is the translation of the camera that we are interest in. Again, we use RANSAC to robustly deal with outliers, where each sample defines a translation according (5) and the final model is also determined by (5) using all inliers. Like the situation in determining rotation, while RANSAC one feature in the process to determine the translation, the final estimate for rotation and translation is based on all inliers that voted for that minimum sample.

One experimental embodiment performs faster than the standard three-point algorithm, while producing at least comparable results. The faster execution is explained by the smaller sample size for each case as compared to three-point. Therefore it is more likely to select randomly a good sample and consequently RANSAC needs fewer iterations, assuming that both have the same inlier ratio.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method for determining a translation and a rotation of a platform in a three-dimensional distribution of a plurality of objects, comprising the steps of:
a. generating at least a first frame and a previous frame of a first two-dimensional projection of a three-dimensional distribution of objects with a first sensor, each frame including a first plurality of features;
b. generating at least a first frame and a previous frame of a second two-dimensional projection of the three-dimensional distribution of objects with a second sensor, each frame including a second plurality of features;
c. matching points in the first two-dimensional projection to points in the second two-dimensional projection in a first frame generated by the first sensor and the second sensor, thereby generating a set of stereo feature matches;
d. matching points in the stereo feature matches to corresponding stereo feature matches in a previous frame generated by the first sensor and the second sensor, thereby generating a set of putative matches;
e. categorizing as near features the putative matches that are nearer to the platform than a threshold and categorizing as distance features the putative matches that are farther to the platform than the threshold;
f. determining the rotation of the platform by measuring a positional change in at least two of the distant features measured between the first frame and the second frame; and
g. determining the translation of the platform by compensating at least one of the near features for the rotation and then measuring a change in the at least one of the near features measured between the first frame and the second frame.

2. The method of claim 1, further comprising the step of determining the threshold as a function of the speed of the platform.

3. The method of claim 1, wherein the categorizing step comprises the steps of:
a. comparing a disparity between a point of a selected feature in the first two-dimensional projection and a point of the selected feature in the second two-dimensional projection;
b. designating the point as a near point when the disparity is greater than a disparity threshold; and
c. designating the point as a distant point when the disparity is less than the disparity threshold.

4. The method of claim 1, wherein the step of determining the rotation comprises:
a. repeatedly generating a rotational model based on a positional change of a first distance feature and a second distance feature between the first frame and the previous frame for a plurality of first distance features and second distance features selected from the putative matches, thereby resulting in a plurality of rotational models;
b. employing an iterative statistical method to determine which of the rotational models best corresponds to the distance features in the putative matches; and
c. selecting the rotational model that best corresponds to the distance features in the putative matches to represent the rotation.

5. The method of claim 4, wherein the step of employing an iterative statistical method comprises employing a random sample consensus algorithm.

6. The method of claim 1, wherein the step of determining the translation comprises:
a. repeatedly generating a translational model based on a positional change of a near feature between the first frame and the previous frame for a plurality of near features selected from the putative matches, thereby resulting in a plurality of translational models;
b. employing an iterative statistical method to determine which of the translational models best corresponds to the near features in the putative matches; and
c. selecting the translational model that best corresponds to the near features in the putative matches to represent the translation.

7. The method of claim 6, wherein the step of employing an iterative statistical method comprises employing a random sample consensus algorithm.

8. The method of claim 1, wherein the generating steps each comprise using a camera to generate the first frame and the previous frame.

9. A method, operable on a processor, for determining a translation and a rotation of a platform in a three-dimensional distribution of a plurality of objects, comprising the steps of:
a. generating at least a first frame and a previous frame of a first two-dimensional projection of a three-dimensional distribution of objects with a first camera, each frame including a first plurality of features;
b. generating at least a first frame and a previous frame of a second two-dimensional projection of the three-dimensional distribution of objects with a second camera, each frame including a second plurality of features;
c. matching points in the first two-dimensional projection to points in the second two-dimensional projection in a first frame generated by the first camera and the second camera, thereby generating a set of stereo feature matches;
d. matching points in the stereo feature matches to corresponding stereo feature matches in a previous frame generated by the first camera and the second camera, thereby generating a set of putative matches;
e. categorizing as near features the putative matches that are nearer to the platform than a threshold and categorize as distance features the putative matches that are farther to the platform than the threshold;
f. determining the rotation of the platform by executing the following steps:
i. repeatedly generating a rotational model based on a positional change of a first distance feature and a second distance feature between the first frame and the previous frame for a plurality of first distance features and second distance features selected from the putative matches, thereby resulting in a plurality of rotational models;
ii. employing an iterative statistical method to determine which of the rotational models best corresponds to the distance features in the putative matches; and
iii. selecting the rotational model that best corresponds to the distance features in the putative matches to represent the rotation; and
g. compensating at least one of the near features for the rotation and then determining translation by executing the following steps:
i. repeatedly generating a translational model based on a positional change of a near feature between the first frame and the previous frame for a plurality of near features selected from the putative matches, thereby resulting in a plurality of translational models;
ii. employing the iterative statistical method to determine which of the translational models best corresponds to the near features in the putative matches; and
iii. selecting the translational model that best corresponds to the near features in the putative matches to represent the translation.

10. The method of claim 9, further comprising the step of determining the threshold as a function of the speed of the platform.

11. The method of claim 9, wherein the step of employing an iterative statistical method comprises employing a random sample consensus algorithm.

12. An apparatus for determining a translation and a rotation of a platform in a three-dimensional distribution of a plurality of objects, comprising:
a. a first sensor configured to project the three-dimensional distribution onto a first two-dimensional projection, the first two-dimensional projection including a first plurality of points that each correspond to a different object of the plurality of objects;
b. a second sensor configured to project the three-dimensional distribution onto a second two-dimensional projection, the first two-dimensional projection including a second plurality of points that each correspond to a different object of the plurality of objects; and
c. a processor, in communication with the first sensor and the second sensor, configured to execute the following steps:
i. match points in the first two-dimensional projection to points in the second two-dimensional projection in a first frame generated by the first sensor and the second sensor, thereby generating a set of stereo feature matches;
ii. match points in the stereo feature matches to corresponding stereo feature matches in a previous frame generated by the first sensor and the second sensor, thereby generating a set of putative matches;
iii. categorize as near features the putative matches that are nearer to the platform than a threshold and categorize as distance features the putative matches that are farther to the platform than the threshold;
iv. determine the rotation of the platform by measuring a change in at least two of the distant features measured between the first frame and the second frame; and
v. determine the translation of the platform by compensating at least one of the near features for the rotation and then measuring a change in the at least one of the near features measured between the first frame and the second frame.

13. The apparatus of claim 12, wherein the processor compares a disparity between a point of a selected feature in the first two-dimensional projection and a point of the selected feature in the second two-dimensional projection and wherein the point is categorized as a near point when the disparity is greater than a disparity threshold and wherein the point is categorized as a distant point when the disparity is less than the disparity threshold.

14. The apparatus of claim 12, wherein the first sensor and the second sensor each comprise a camera.

15. The apparatus of claim 12, wherein the processor determines the rotation by executing the following:
a. repeatedly generate a rotational model based on a positional change of a first distance feature and a second distance feature between the first frame and the previous frame for a plurality of first distance features and second distance features selected from the putative matches, thereby resulting in a plurality of rotational models;
b. employ an iterative statistical method to determine which of the rotational models best corresponds to the distance features in the putative matches; and
c. select the rotational model that best corresponds to the near features in the putative matches to represent the rotation.

16. The apparatus of claim 15, wherein the step of employing an iterative statistical method comprises employing a random sample consensus algorithm.

17. The apparatus of claim 12, wherein the processor determines the translation by executing the following:
a. repeatedly generate a translational model based on a positional change of a near feature between the first frame and the previous frame for a plurality of near features selected from the putative matches, thereby resulting in a plurality of translational models;
b. employ an iterative statistical method to determine which of the translational models best corresponds to the near features in the putative matches; and
c. select the translational model that best corresponds to the near features in the putative matches to represent the translation.

18. The apparatus of claim 17, wherein the step of employing an iterative statistical method comprises employing a random sample consensus algorithm.

19. The apparatus of claim 12, wherein the processor determines the threshold as a function of the speed of the platform.
